(19) United States
(12) Patent Application Publication
(10) Pub. No.: US 2015/0367258 A1
(43) Pub. Date: Dec. 24, 2015

(54) FILTRATION ASSEMBLY INCLUDING ABUTTING FILTRATION ELEMENTS WITH END CAPS FORMING COMMON ANNULAR GROOVE

(71) Applicant: Dow Global Technologies LLC, Midland, MI (US)

(72) Inventors: Jon E. Johnson, Plymouth, MN (US); Christopher J. Siler, Hemlock, MI (US); Robert K. McIntyre, Mcmurry, PA (US)

(73) Assignees: Filmtec Corporation, Edina, MN (US); The Dow Chemical Company, Midland, MI (US); Dow Global Technologies LLC, Midland, MI (US)

(21) Appl. No.: 14/384,394

(22) PCT Filed: Jan. 27, 2014
(86) PCT No.: PCT/US2014/013103

§ 371 Date: Sep. 11, 2014

Related U.S. Application Data
(60) Provisional application No. 61/759,439, filed on Feb. 1, 2013.

(51) Int. Cl. B01D 29/58; B01D 29/07

(52) U.S. Cl. CPC B01D 29/58; B01D 29/073

(57) ABSTRACT

A filter assembly (10) including a first (12) and second (14) filtration element positioned in an abutting end-to-end arrangement along a common axis (X). Both filtration elements (12, 14) include a cylindrical housing (16, 16′) enclosing a filtration media and extending along the axis (X) between opposing ends, and an end cap (18, 20, 18′, 20′) located at each of the abutting ends of the filtration elements (12, 14) and comprising an annular surface (28, 28′) co-extensive with the housing (16, 16′) and an annular stepped edge (29, 29′). The first (12) and second (14) filtration elements are positioned with their end caps (18, 20′) directly engaged with each other so that the stepped edges (29, 29′) collectively form a continuous annular groove (31) about the periphery of the filter assembly (10). The annular groove (31) provides an effective means for handling filtration elements without increasing the overall length of end cap.

### FIELD

The present invention is directed toward filtration assemblies including multiple filtration elements positioned in an end-to-end arrangement with novel abutting end caps.

### INTRODUCTION

End caps are commonly used to interconnect individual filtration elements in an end-to-end arrangement within a pressure vessel. In a typical arrangement, end caps are secured to the ends of filtration elements and are adapted to engage with an end cap of an adjacently positioned filtration element. The specific nature of engagement between end caps of adjacent filtration elements varies depending upon the specific type of element and filter assembly; however, in many applications the engagement involves perfecting a fluid seal or mechanical connection between adjacent elements or the surrounding pressure vessel. End caps are typically circular with an annular surface that is co-extensive with the housing of the filtration element. Representative examples are described in U.S. Pat. Nos. 5,851,267, 6,224,767, 6,632,356, 7,063,789, 717,269, 7,198,719, 7,387,731, 8,034,241, and 8,425,773. Various types of seals may be used to prevent fluid flow between the housing of a filtration element and the pressure vessel. For example, radial brine seals (e.g. Chevron-type, O-rings, U-cup type, etc.) are commonly located about the annular surface of the end cap and engage the inner wall of the pressure vessel. Examples are described in: U.S. Pat. No. 5,128,037, 6,299,772, 8,110,016 and 8,425,773. In some embodiments, such seals are located within an annular groove provided within the annular surface of the end cap.

In addition to standard horizontally positioned element configurations, filtration elements may also be stacked vertically, see for example U.S. Pat. No. 8,480,894 and US 2012/0111785. With vertical embodiments, installation of filtration elements within a common pressure vessel can be more challenging, both in terms of the total weight of the assembly and the difficulty in handling (manipulating) individual elements. While indents can be machined into the end caps to facilitate handling, these type of features require that the element be orientated during installation. Use of an annular groove (e.g. the groove used to receive a brine seal) is also disadvantaged due to the force applied to the adjacent walls which define the groove. Elongating the end cap to provide more structural support for an annular groove is also disadvantaged as it reduces the area of the filtration element dedicated to filtration.

### SUMMARY

The invention includes a filter assembly (10) including a first (12) and second (14) filtration element positioned in an abutting end-to-end arrangement along a common axis (X). Both filtration elements (12, 14) include a cylindrical housing (16, 16′) enclosing a filtration media and extending along the axis (X) between opposing ends, and an end cap (18, 20, 18′, 20′) located at each of the abutting ends of the filtration elements (12, 14) and comprising an annular surface (28, 28′) co-extensive with the housing (16, 16′) and an annular stepped edge (29, 29′). The first (12) and second (14) filtration elements are positioned with their end caps (18, 20′) directly engaged with each other so that the stepped edges (29, 29′) collectively form a continuous annular groove (31) about the periphery of the filter assembly (10). The annular groove (31) provides an effective means for handling filtration elements without increasing the axial length of end cap.

### BRIEF DESCRIPTION OF THE DRAWINGS

The figures are not to scale and include idealized views to facilitate description. Where possible, like numerals have been used throughout the figures and written description to designate the same or similar features.

FIG. 1A is a perspective view of a filtration assembly including two filtration elements positioned in end-to-end arrangement along a common axis X within a pressure vessel.

FIG. 1B is an enlarged, cut away view of an end cap shown in FIG. 1A.

FIG. 2A is an elevation view showing the engagement of the end caps from two filtration elements positioned in a vertical, abutting end-to-end arrangement.

FIG. 2B is an enlarged, cut away view of abutting end caps shown in FIG. 2A.

### DETAILED DESCRIPTION

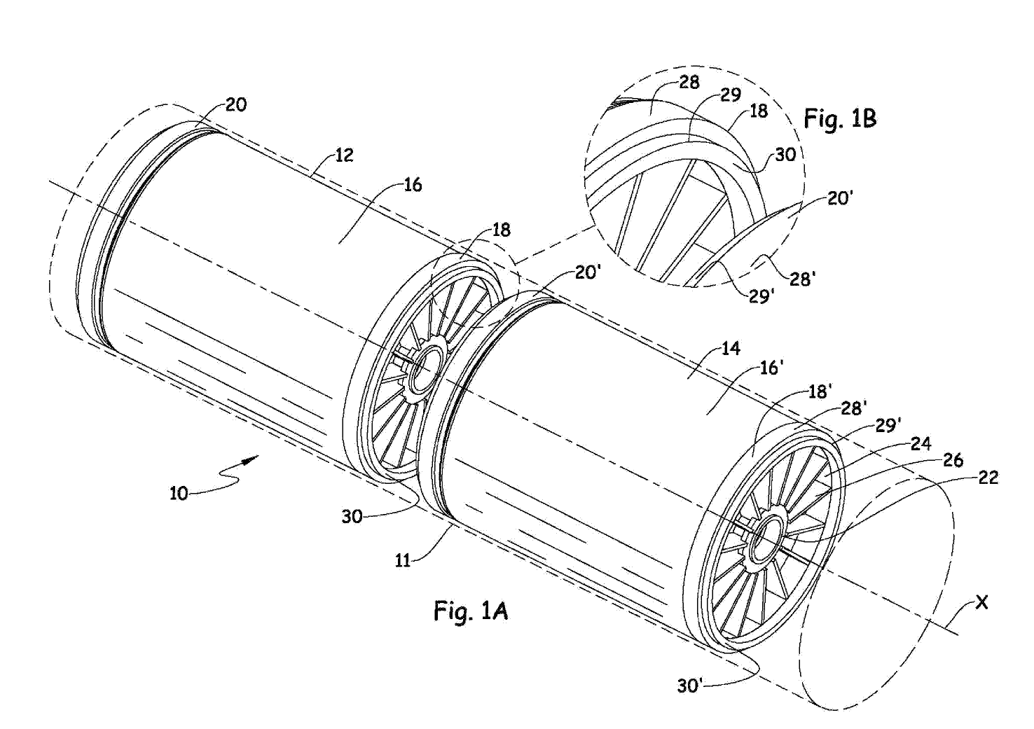

A filtration assembly is generally shown at 10 in FIG. 1A including a first (12) and second (14) filtration element positioned in an end-to-end arrangement along an axis (X) within a pressure vessel (11). Each filtration element (12, 14) includes a cylindrical housing (16, 16′) enclosing a filtration media (not shown) extending along axis (X) between opposing ends. An end cap (18, 20, 18′, 20′) is secured to each end of each filtration element (12, 14). Each end cap (18, 20, 18′, 20′) has a circular shape including an inner hub (22) connected to an outer hub (24) by a plurality of spokes (26). While the end caps are shown having a concentric hub and spoke design, other configurations may be used, e.g. a solid outer face include a plurality of holes for providing fluid flow such as described in U.S. Pat. No. 7,198,719.

The end caps (18, 20, 18′, 20′) may have a circumference or outer periphery slightly larger than the housing (16, 16′) but once fitted upon the element, are generally co-extensive with the housing (16, 16′). In this context, the term “co-extensive” means that the two structures share a similar planar boundary along a common axis. Each end cap (18, 20, 18′, 20′) further includes an annular surface (28, 28′) which is co-extensive with the housing (16, 16′) of the filtration element and an annular stepped edge (29, 29′) located at or near the axial end of the end cap. Each end cap (18, 20, 18′, 20′) further includes an outer face (30) laying in a plane perpendicular to the common axis (X). The outer face (30) of the end cap (18) is adapted to engage with an abutting outer face of an end cap (20) of an adjacently positioned filtration element.

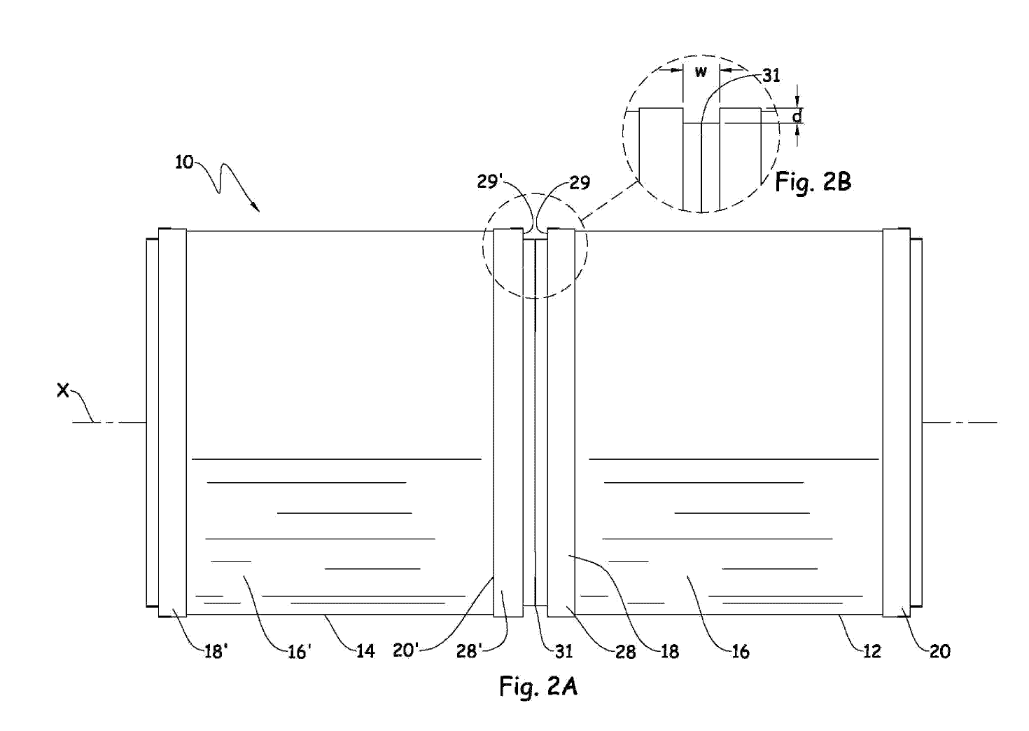

During assembly, a plurality of filtration elements are aligned in an abutting end-to-end arrangement, e.g. within a common pressure vessel (11), such that the end caps of adjacent elements directly engaged each other so that the stepped edges (29, 29′) collectively form a continuous annular groove (31) about the periphery of the filter assembly (10). As best shown in FIGS. 2A and 2B, the resulting annular groove (31) extends about the entire outer periphery of the joined filtration elements (12, 14). In preferred embodiments, the annular groove (31) has a substantially rectangular or U-shaped cross-section with both a radial depth (d) and axial width (w) of from 3 to 10 mm. The annular groove (31) provides a structural feature for handling the filtration elements. This feature is particularly useful when installing multiple filtration elements in a vertical arrangement particularly larger elements or with assemblies including multiple filtration elements in end-to-end relationship, e.g. often from 2 to 10 elements within a common pressure vessel.

The end cap (18) including the annular surface (28) and stepped edge (29) comprise an integrally molded unit. Alternatively, the stepped edge (or other features) may be machined into the end cap.

The design and construction of the pressure vessel is not particularly limited but preferably includes at least one fluid inlet and outlet. While shown in the Figures as being aligned along a horizontal axis, the pressure vessel and filtration elements may be aligned along a common vertical axis.

While not a required aspect of the invention, the end caps may include a locking structure for preventing relative axial movement between engaged end caps. Such a locking structure between end caps may be engaged by aligning adjacent end caps so that one or more projections or catches extending radially inward from the inside of the outer hub of one end cap enter corresponding receptacles arranged about the outer hub of the facing end cap. The end caps are then engaged by rotating one end cap relative to the other until the projections or “catches” contact or “hook” with a corresponding structure of the receptacle. This type of locking structure is described in U.S. Pat. No. 6,632,356. The first end cap may additionally, or alternatively includes a depressible tab located on the annular surface which is movable in a radial direction between a first (e.g. extended) and second (e.g. depressed) position. The second end cap may include a slot, (preferably a plurality of slots), located on its annular surface that is adapted for receiving the tab of the first end cap as the first and second end caps are engaged such that relative rotational movement between the first and second end caps is prevented while the tab is in an extended position within the slot, but where such relative rotational movement is permitted when the tab is in a depressed position. This type of locking structure is described in US 2011/0042294. When used in combination with the locking structures of U.S. Pat. No. 6,632,356, the tab/slot feature can selectively prevent both relative axial and rotational motion between end caps (and corresponding filtration elements). That is, once engaged, the “tab/slot” feature selectively prevents relative rotational movement between end caps, which in turn maintains the locking structure in full engagement so that relative axial movement between the end caps is also prevented. Thus, end caps (and corresponding filtration elements) can be selectively disengaged and disconnected by depressing the tab located on the annular surface of the end cap and rotating one end cap relative to the other. This combination of features is also helpful as it provides a clearer indication of when the end caps are fully engaged and interconnected. Moreover, the tab/slot feature prevents unintended rotation between filtrations elements which may otherwise occur during installation within a pressure vessel or during operation.

For purposes of the present invention, the type of filtration media within the filtration element is not particularly limited. The selection of filtration media will typically depend upon the specific application, feed source, solute, and foulants. Representative examples include membrane-based media such as composite flat sheet, hollow fiber and tubular membranes which may be used in a wide variety of applications including: reverse osmosis (RO), forward osmosis (FO) nanofiltration (NF), ultrafiltration (UF) and microfiltration (MF). Other media examples include granular, powder or particle form adsorbents, ion exchange and chelating resins. Spiral wound elements are one preferred type of filtration element. Such elements are typically formed by winding one or more membrane envelopes and optional feed channel spacer sheet(s) (“feed spacers”) about a permeate collection tube. Each membrane envelope preferably comprises two substantially rectangular membrane sheets surrounding a permeate channel spacer sheet (“permeate spacer”). This sandwich-type structure is secured together, e.g. by sealant, along three edges while the fourth edge abuts the permeate collection tube so that the permeate spacer is in fluid contact with openings passing through the permeate collection tube. The housing may be constructed from a variety of materials including stainless steel, tape and PVC material; however the most common module housing material is made from fiber reinforced plastics, e.g. long glass fibers coated with a thermoplastic or thermoset resin. During module fabrication, long glass fibers are wound about the partially constructed module and resin (e.g. liquid epoxy) is applied and hardened. The ends of elements are fitted with an end cap which may optionally serve as an anti-telescoping device designed to prevent membrane envelopes from shifting under the pressure differential between the inlet and outlet ends of the element.

Many embodiments of the invention have been described and in some instances certain embodiments, selections, ranges, constituents, or other features have been characterized as being “preferred”. Such designations of “preferred” features should in no way be interpreted as an essential or critical aspect of the invention. The entire content of each of the aforementioned patents and patent applications are incorporated herein by reference.

1. A filter assembly (10) comprising a first (12) and second (14) filtration element positioned in an abutting end-to-end arrangement along a common axis (X), wherein each filtration element comprises:
a cylindrical housing (16, 16′) enclosing a filtration media and extending along the axis (X) between opposing ends,
an end cap (18, 20, 18′, 20′) located at each of the abutting ends of the filtration elements (12, 14) and comprising an annular surface (28, 28′) co-extensive with the housing (16, 16′) and an annular stepped edge (29, 29′),
wherein the first (12) and second (14) filtration elements are positioned with their end caps (18, 20′) directly engaged which each other so that the stepped edges (29, 29′) collectively form a continuous annular groove (31) about the periphery of the filter assembly (10).

2. The filter assembly (10) of claim 1 wherein the annular groove (31) has a rectangular cross-section.

3. The filter assembly (10) of claim 1 wherein the annular groove (31) has both a radial depth and axial width of from 3 to 10 mm.

4. The filter assembly (10) of claim 1 wherein the end cap (18) including the annular surface (28) and stepped edge (29) comprise an integrally molded unit.

5. The filter assembly (10) of claim 1 wherein the first and second filtration elements (12, 14) comprise spiral wound elements.

6. The filter assembly (10) of claim 1 wherein the first and second filtration elements (12, 14) are vertically positioned within a pressure vessel (11).
